(19) United States
(12) Patent Application Publication
(10) Pub. No.: US 2026/0170412 A1
(43) Pub. Date: Jun. 18, 2026

(54) INFORMATION PROCESSING APPARATUS, INFORMATION PROCESSING METHOD, AND COMPUTER-READABLE MEDIUM

(71) Applicant: NEC Corporation, Tokyo (JP)

(72) Inventors: Takuya Tamura, Tokyo (JP); Taro Yano, Tokyo (JP); Masafumi Oyamada, Tokyo (JP)

(73) Assignee: NEC Corporation, Tokyo (JP)

(21) Appl. No.: 19/404,148

(22) Filed: Dec. 1, 2025

(30) Foreign Application Priority Data
Dec. 12, 2024 (JP) 2024-218090

(51) Int. Cl. G06N 20/00

(52) U.S. Cl. CPC G06N 20/00

(57) ABSTRACT

An information processing apparatus according to an aspect includes one or more memories that store an instruction and one or more processors that execute the instruction. The one or more processors execute the instruction to perform acquiring evaluation information of at least one of one or a plurality of language models, the evaluation information being evaluation information of the language model related to at least one of one or a plurality of problems, acquiring meta-information regarding the at least one language model of the one or the plurality of language models, and performing performance estimation processing regarding the at least one of the one or the plurality of language models with reference to the evaluation information and the meta-information. This facilitates AI-driven decision making in selecting an optimal language model.

### INCORPORATION BY REFERENCE

This application is based upon and claims the benefit of priority from Japanese patent application No. 2024-218090, filed on Dec. 12, 2024, the disclosure of which is incorporated herein in its entirety by reference.

### TECHNICAL FIELD

The present disclosure relates to an information processing apparatus, an information processing method, and a program.

### BACKGROUND ART

With development of a language model (LM) using machine learning, a technology for evaluating performance of the language model has been proposed. For example, Felipe Maia Polo et al., tinyBenchmarks: evaluating LLMs with fewer examples, arXiv: 2402.14992 (May 2024) discloses a technique for calculating a language model feature amount (large language model (LLM) feature amount) and a problem feature amount from a score of an evaluated pair of a problem and a language model and estimating a score of an unevaluated pair by using the language model feature amount and the problem feature amount in performance evaluation of an LLM.

### SUMMARY

However, the technique described in Felipe Maia Polo et al., tinyBenchmarks: evaluating LLMs with fewer examples, arXiv: 2402.14992 (May 2024) has a problem that performance estimation cannot be performed on a language model for which an evaluated pair (evaluation information) has not been obtained.

The present disclosure has been made in view of the above problem, and an example object thereof is to provide a technique capable of suitably performing performance estimation even on a language model for which evaluation information has not been obtained.

An information processing apparatus according to an example aspect of the present disclosure includes one or more memories that store an instruction and one or more processors that execute the instruction, wherein the one or more processors execute the instruction to perform acquiring evaluation information of at least one of one or a plurality of language models, the evaluation information being evaluation information of the language model related to at least one of one or a plurality of problems, acquiring meta-information regarding the at least one language model of the one or the plurality of language models, and performing performance estimation processing regarding the at least one of the one or the plurality of language models with reference to the evaluation information and the meta-information.

An information processing method according to an example aspect of the present disclosure includes causing one or more processors to perform acquiring evaluation information of at least one of one or a plurality of language models, the evaluation information being evaluation information of the language model related to at least one of one or a plurality of problems, acquiring meta-information regarding the at least one language model of the one or the plurality of language models, and performing performance estimation processing regarding the at least one of the one or the plurality of language models with reference to the evaluation information and the meta-information.

A program according to an example aspect of the present disclosure is a program for causing a computer to perform acquiring evaluation information of at least one of one or a plurality of language models, the evaluation information being evaluation information of the language model related to at least one of one or a plurality of problems, acquiring meta-information regarding the at least one language model of the one or the plurality of language models, and performing performance estimation processing regarding the at least one of the one or the plurality of language models with reference to the evaluation information and the meta-information.

According to an example aspect of the present disclosure, there is an exemplary effect that performance estimation can suitably be performed even on a language model for which evaluation information has not been obtained.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a diagram for illustrating an example of problem setting handled by the information processing system according to the present disclosure;

FIG. 5 is a flowchart illustrating an example of a processing flow in the information processing system according to the present disclosure;

FIG. 6 is a diagram for illustrating a processing example in the information processing system according to the present disclosure;

FIG. 7 is a diagram for illustrating a processing example in the information processing system according to the present disclosure;

FIG. 8 is a diagram for illustrating a processing example in the information processing system according to the present disclosure; and

FIG. 9 is a block diagram illustrating a configuration of a computer that functions as the information processing apparatus according to the present disclosure.

### EXAMPLE EMBODIMENTS

Hereinafter, example embodiments of the present disclosure will be exemplified. However, the present disclosure is not limited to the following exemplary example embodiments, and various modifications can be made within a scope described in the claims. For example, example embodiments obtained by appropriately combining technologies (some or all of things or methods) adopted in the following exemplary example embodiments can also be included in the scope of the present disclosure. Example embodiments obtained by appropriately omitting some of the technologies adopted in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in each of the following exemplary example embodiments can also be included in the scope of the present disclosure.

Further, each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in another exemplary example embodiment included in the present disclosure within a range in which no particular technical problem occurs.

### (Configuration of Information Processing Apparatus 1)

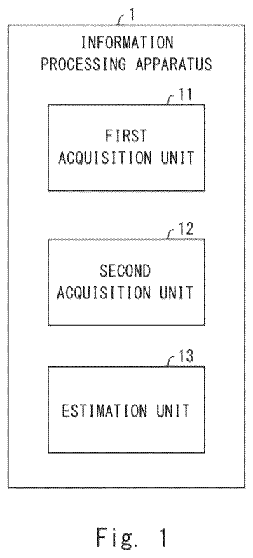

A configuration of an information processing apparatus 1 according to the present exemplary example embodiment will be described with reference to FIG. 1. FIG. 1 is a block diagram illustrating a configuration of the information processing apparatus 1. As illustrated in FIG. 1, the information processing apparatus 1 includes a first acquisition unit 11, a second acquisition unit 12, and an estimation unit 13.

### (First Acquisition Unit 11)

The first acquisition unit 11 acquires evaluation information regarding at least one language model of one or a plurality of language models. Here, the one or the plurality of language models can include, as an example, a large language model (LLM) machine-learned in advance. Furthermore, the evaluation information includes, as an example, a result of evaluating the language model by using at least one of one or a plurality of problems. More specifically, the evaluation information includes, as an example, a result of causing the language model to solve the at least one of the one or the plurality of problems. Therefore, it can be expressed that the first acquisition unit 11 acquires the evaluation information of the at least one of the one or the plurality of language models, the evaluation information being the evaluation information of the language model related to the at least one of the one or the plurality of problems.

In addition, the evaluation information includes, as an example, a score in an evaluated pair that is a pair of the at least one language model of the one or the plurality of language models and a problem solved by the language model. However, this does not limit the present exemplary example embodiment. Note that the evaluation information can also be expressed as evaluation information of the problem related to the language model that has solved the problem.

### (Second Acquisition Unit 12)

The second acquisition unit 12 acquires meta-information regarding the at least one language model of the one or the plurality of language models. Here, as an example, the meta-information regarding the language model indicates information other than the evaluation information regarding the language model. For a language model for which the evaluation information has not been obtained, the second acquisition unit 12 acquires meta-information of the language model. Furthermore, for a language model for which the evaluation information has been obtained, the second acquisition unit 12 may further acquire meta-information of the language model.

Note that the specific example of the meta-information of the language model does not limit the present exemplary example embodiment, but can include, as an example, any of the following information:
a name of the language model;
a parameter referred to by the language model;
a data set used for training of the language model;
a developer of the language model;
a development time of the language model;
an architecture of the language model;
a history of model merge regarding the language model;
a history of additional training of the language model;
and the like. Here, the history of the additional training can include, as an example, relationship information such as “a certain model is fine-tuned to become another model”. The history of the model merge regarding the language model and the history of the additional training of the language model may be combined and expressed as a history regarding the language model.

### (Estimation Unit 13)

The estimation unit 13 performs performance estimation processing regarding the at least one of the one or the plurality of language models, with reference to the evaluation information acquired by the first acquisition unit 11 and the meta-information of the language model acquired by the second acquisition unit 12. As an example of the performance estimation processing, the estimation unit 13 estimates a score in an unevaluated pair that is a pair of the language model of one of the one or the plurality of language models and a problem that is not solved by the language model.

Furthermore, as an example, the estimation unit 13 may be configured to estimate the score in the unevaluated pair, with reference to a first loss according to the score in the evaluated pair and a second loss (also referred to as a constraint term) according to the meta-information acquired by the second acquisition unit 12. Further, in the calculation of the second loss, the estimation unit 13 may adopt a configuration that:
calculates a similarity between the plurality of language models with reference to the meta-information; and
calculates the second loss by using the calculated similarity. However, these examples do not limit the present exemplary example embodiment.

### (Effect of Information Processing Apparatus 1)

As described above, the information processing apparatus 1 adopts the configuration that:
acquires the evaluation information of the at least one of the one or the plurality of language models, the evaluation information being the evaluation information of the language model related to the at least one of the one or the plurality of problems;
acquires the meta-information regarding the at least one language model of the one or the plurality of language models; and
performs the performance estimation processing regarding the at least one of the one or the plurality of language models with reference to the evaluation information and the meta-information. As described above, since the information processing apparatus 1 acquires the meta-information regarding the at least one language model of the one or the plurality of language models and performs the performance estimation processing regarding the at least one of the one or the plurality of language models with reference to the meta-information, performance estimation can suitably be performed even for the language model for which the evaluation information has not been obtained.

### (Flow of Information Processing Method S1)

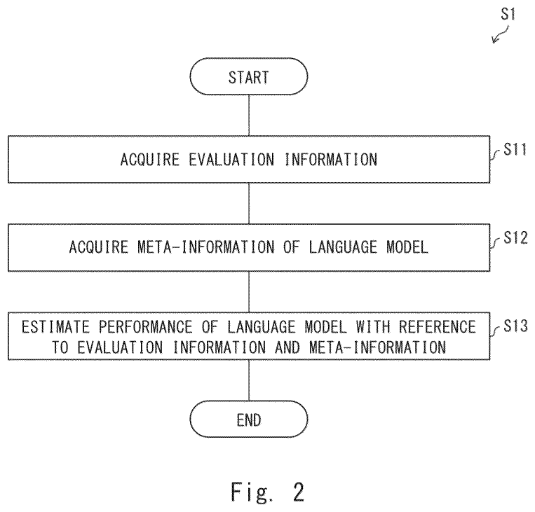

Subsequently, a flow of an information processing method S1 according to the present exemplary example embodiment will be described with reference to FIG. 2. FIG. 2 is a flowchart illustrating the flow of the information processing method S1. As illustrated in FIG. 2, the information processing method S1 includes step (process) S11 of acquiring the evaluation information, step (process) S12 of acquiring the meta-information, and step (process) S13 of estimating performance of the language model.

### (Step S11)

In step S11, the first acquisition unit 11 acquires the evaluation information of the at least one of the one or the plurality of language models, the evaluation information being the evaluation information of the language model related to the at least one of the one or the plurality of problems. Since the more specific description of the first acquisition unit 11 has been described above, the description thereof will be omitted here.

### (Step S12)

In step S12, the second acquisition unit 12 acquires the meta-information regarding the at least one language model of the one or the plurality of language models. Since the more specific description of the second acquisition unit 12 has been described above, the description thereof will be omitted here.

### (Step S13)

In step S13, the estimation unit 13 performs the performance estimation processing regarding the at least one of the one or the plurality of language models, with reference to the evaluation information acquired by the first acquisition unit 11 in step S11 and the meta-information of the language model acquired by the second acquisition unit 12 in step S12. Since the more specific description of the estimation unit 13 has been described above, the description thereof will be omitted here.

### (Effect of Information Processing Method S1)

As described above, the information processing method S1 adopts the configuration that:
acquires the evaluation information of the at least one of the one or the plurality of language models, the evaluation information being the evaluation information of the language model related to the at least one of the one or the plurality of problems;
acquires the meta-information regarding the at least one language model of the one or the plurality of language models; and
performs the performance estimation processing regarding the at least one of the one or the plurality of language models with reference to the evaluation information and the meta-information. The configuration described above achieves an effect similar to that of the information processing apparatus 1.

### Second Example Embodiment

A second exemplary example embodiment that is an example of the example embodiments of the present disclosure will be described in detail with reference to the drawings. Components that have the same functions as the components described in the above-described exemplary example embodiment are denoted by the same reference signs, and will not be described as appropriate. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in each drawing referred to for describing the present exemplary example embodiment can also be adopted in another exemplary example embodiment included in the present disclosure within a range in which no particular technical problem occurs.

### (Configuration of Information Processing System 100A)

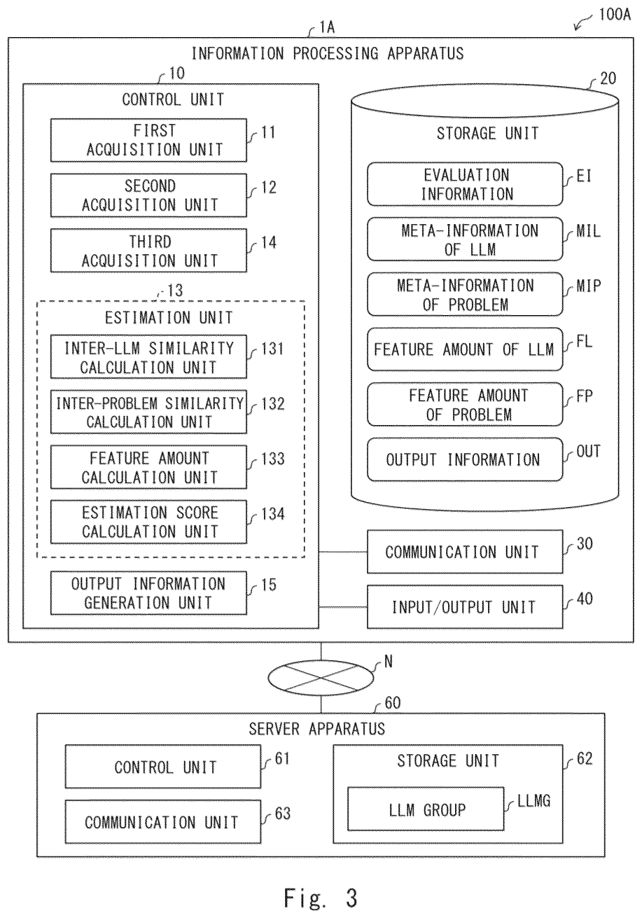

A configuration of an information processing system 100A according to the present exemplary example embodiment will be described with reference to FIG. 3. FIG. 3 is a block diagram illustrating the configuration of the information processing system 100A. As illustrated in FIG. 3, the information processing system 100A includes an information processing apparatus 1A and a server apparatus 60 connected to the information processing apparatus 1A via a network N. Here, a specific configuration of the network N does not limit the present exemplary example embodiment, but as an example, a wireless local area network (LAN), a wired LAN, a wide area network (WAN), a public line network, a mobile data communication network, or a combination of these networks can be used.

### (Server Apparatus 60)

As illustrated in FIG. 3, the server apparatus 60 includes a control unit 61, a storage unit 62, and a communication unit 63. The communication unit 63 communicates with an apparatus outside the server apparatus 60. For example, the communication unit 63 communicates with the information processing apparatus 1A provided in the information processing system 100A. The communication unit 63 transmits data supplied from the control unit 61 to the information processing apparatus 1A, and supplies data received from the information processing apparatus 1A to the control unit 61. The data received by the communication unit 63 from the information processing apparatus 1A can include a problem group provided from the information processing apparatus 1A. Furthermore, the data provided by the communication unit 63 to the information processing apparatus 1A can include a result of solving at least one of one or a plurality of problems included in the problem group by at least one of one or a plurality of language models included in a language model group LLMG to be described later.

The storage unit 62 stores the language model group LLMG including the one or the plurality of language models. As an example, the storage unit 62 stores a plurality of parameters defining the one or the plurality of language models. These parameters are, as an example, parameters learned in advance through machine learning (parameters subjected to update processing through machine learning), but this does not limit the present exemplary example embodiment. A large language model subjected to machine learning can be used as the language model.

The control unit 61 acquires information generated by the language model by using the language model. As an example, the control unit 61 inputs a prompt including a problem received from the information processing apparatus 1A to the language model, and acquires a result of solving the problem by the language model. Furthermore, the result is provided to the information processing apparatus 1A via the communication unit 63.

Although the server apparatus 60 is exemplified as an apparatus separate from the information processing apparatus 1A in the present exemplary example embodiment, this does not limit the present exemplary example embodiment. A control unit of the information processing apparatus 1A may function as the control unit 61 included in the server apparatus 60 or a language model execution unit in the control unit 61. Similarly, the language model group LLMG stored in the storage unit 62 included in the server apparatus 60 may be stored in a storage unit of the information processing apparatus 1A, and the language model group LLMG may be executable by the information processing apparatus 1A itself.

### (Configuration of Information Processing Apparatus 1A)

Next, a configuration of the information processing apparatus 1A according to the present exemplary example embodiment will be described with reference to FIG. 3. As illustrated in FIG. 3, the information processing apparatus 1A includes a control unit 10, a storage unit 20, a communication unit 30, and an input/output unit 40.

### (Communication Unit 30)

The communication unit 30 communicates with an apparatus outside the information processing apparatus 1A. As an example, the communication unit 30 communicates with the server apparatus 60. The communication unit 30 transmits data supplied from the control unit 10 to the server apparatus 60, and supplies the data received from the server apparatus 60 to the control unit 10. Note that the data transmitted from the communication unit 30 to the server apparatus 60 includes a problem group to be solved by the at least one of the one or the plurality of language models included in the language model group LLMG described above. Furthermore, the data received by the communication unit 30 from the server apparatus 60 can include a result of solving the at least one of the one or the plurality of problems included in the problem group by the at least one of the one or the plurality of language models included in the language model group LLMG.

### (Input/Output Unit 40)

The input/output unit 40 includes at least one of input/output devices such as a keyboard, mouse, a display, a printer, and a touch panel. Alternatively, the input/output unit 40 may be connected to input/output equipment such as a keyboard, a mouse, a display, a printer, or a touch panel. This configuration allows the input/output unit 40 to receive inputs of various types of information to the information processing apparatus 1A from the connected input equipment. The input/output unit 40 also outputs various types of information to the connected output equipment under control of the control unit 10. Examples of the input/output unit 40 include an interface such as a universal serial bus (USB).

### (Storage Unit 20)

The storage unit 20 stores various types of data to be referred to by the control unit 10 and various types of data generated by the control unit 10. As an example, the storage unit 20 stores:
evaluation information EI;
meta-information MIL of LLM;
meta-information MIP of problem;
feature amount FL of LLM;
feature amount FP of problem;
output information OUT;
   and the like. Here, as an example, the evaluation information EI includes a result of evaluating at least one of one or a plurality of language models by using at least one of one or a plurality of problems. More specifically, the evaluation information EI includes, as an example, a result of causing the language model to solve the at least one of the one or the plurality of problems. A specific example of the evaluation information EI will be described later.

The meta-information MIL of LLM is information acquired by the second acquisition unit 12 to be described later, and is meta-information regarding at least one language model of one or a plurality of language models. A specific example of the meta-information MIL of LLM will be described later.

The meta-information MIP of problem is information acquired by the third acquisition unit 14 to be described later, and is meta-information regarding at least one problem of one or a plurality of problems. A specific example of the meta-information MIP of problem will be described later.

The feature amount FL of LLM and the feature amount FP of problem are feature amounts calculated by a feature amount calculation unit 133 to be described later. Specific examples of the feature amount FL of LLM and the feature amount FP of problem will be described later.

The output information OUT is information generated by an output information generation unit 15 to be described later, and includes a performance estimation result regarding at least one of one or a plurality of language models. A specific example of the output information OUT will be described later.

### (Example of Problem Setting Handled by Information Processing Apparatus 1A)

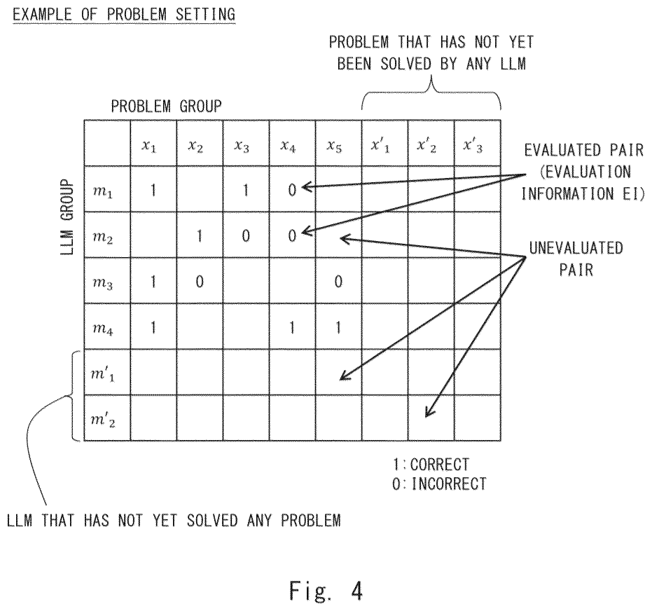

Prior to a more specific description of the information processing apparatus 1A, an example of problem setting handled by the information processing apparatus 1A will be described with reference to FIG. 4. FIG. 4 is a diagram schematically illustrating an example of problem setting handled by the information processing apparatus 1A.

As illustrated in FIG. 4, in the present example, at least one of a plurality of problems (x₁ to x₅, x₁′ to x₃′) included in a problem group is solved by at least one of a plurality of language models (m₁ to m₄, m₁′ to m₂′) included in the language model group LLMG (also referred to as an LLM group). Here, in the example illustrated in FIG. 4, as a score in an evaluated pair that is a pair of a language model and a problem solved by the language model,
1 if a result of solving the problem by the language model is correct
0 if the result of solving the problem by the language model is incorrect is assigned. In the example illustrated in FIG. 4, the score 1 is assigned to an evaluated pair (m₁, x₁), and the score 0 is assigned to an evaluated pair (m₁, x₄). The score of the evaluated pair is an example of the evaluation information EI described above. The calculation of the score may be performed by the control unit 61 of the server apparatus 60 described above or may be performed by the control unit 10 of the information processing apparatus 1A. Note that the specific examples of the score do not limit the present exemplary example embodiment. As an example, the score may be a continuous value.

Meanwhile, in the problem group, some problems are solved by a certain language model but are not solved by another language model. For example, the problem x₄ is solved by the language models m₁, m₂, and m₄, but is not solved by the language model m₃. In addition, in the problem group, some problems are not solved by any language model. For example, the problems x₁′ to x₃′ are not solved by any language model. A pair of such a problem and a language model that does not solve the problem is referred to as an unevaluated pair. As an example, a pair (m₂, x₅) is an unevaluated pair.

In addition, in the language model group LLMG, there is a language model that does not solve any problem. In the example of FIG. 4, the language models m₁′ to m₂′ do not solve any problem. A pair (m₁′, x₅), a pair (m₂′, x₂), and the like are also examples of unevaluated pairs.

The information processing apparatus 1A according to the present exemplary example embodiment performs processing of estimating the score related to the unevaluated pair described above, as an example of the performance estimation processing of the at least one language model of the one or the plurality of language models included in the language model group LLMG.

### (Control Unit 10)

Returning to FIG. 3, a configuration of the control unit 10 of the information processing apparatus 1A will be described. As illustrated in FIG. 3, the control unit 10 includes the first acquisition unit 11, the second acquisition unit 12, the third acquisition unit 14, the estimation unit 13, and the output information generation unit 15.

### (First Acquisition Unit 11)

The first acquisition unit 11 acquires the evaluation information EI of the at least one of the one or the plurality of language models, the evaluation information EI being the evaluation information EI of the language model related to the at least one of the one or the plurality of problems. Here, the evaluation information EI includes, as described above, the score in the evaluated pair that is the pair of the at least one language model of the one or the plurality of language models and the problem solved by the language model. Since the specific examples of the evaluation information, the evaluated pair, and the like have been described above, the description thereof will be omitted here. Note that the evaluation information EI can also be expressed as evaluation information of the problem related to the language model that has solved the problem.

### (Second Acquisition Unit 12)

The second acquisition unit 12 acquires the meta-information MIL regarding the at least one language model of the one or the plurality of language models. Here, as an example, the meta-information MIL regarding the language model indicates information other than the evaluation information EI regarding the language model. For a language model for which the evaluation information EI has not been obtained, the second acquisition unit 12 acquires the meta-information MIL of the language model. Furthermore, for a language model for which the evaluation information EI has been obtained, the second acquisition unit 12 may further acquire the meta-information MIL of the language model.

Note that the specific example of the meta-information MIL of the language model does not limit the present exemplary example embodiment, but as in the first exemplary example embodiment, can include, as an example, any of the following information:
a name of the language model;
a parameter referred to by the language model;
a data set used for training of the language model;
a developer of the language model;
a development time of the language model;
an architecture of the language model;
a history of model merge regarding the language model;
a history of additional training of the language model;
   and the like. Here, the history of the additional training can include, as an example, relationship information such as “a certain model is fine-tuned to become another model”. The history of the model merge regarding the language model and the history of the additional training of the language model may be combined and expressed as a history regarding the language model.

### (Third Acquisition Unit 14)

The third acquisition unit 14 acquires the meta-information MIP regarding the at least one problem of the one or the plurality of problems. Here, as an example, the meta-information MIP regarding the problem indicates information other than the evaluation information EI regarding the problem. For a problem for which the evaluation information EI has not been obtained, the third acquisition unit 14 acquires the meta-information MIP of the problem. Furthermore, for a problem for which the evaluation information EI has been obtained, the third acquisition unit 14 may further acquire the meta-information MIP of the problem.

Note that the specific example of the meta-information MIP of problem does not limit the present exemplary example embodiment, but can include, as an example, any of the following information:
a sentence of the problem (also referred to as a problem sentence or a prompt sentence);
a source of the problem;
a creator of the problem;
date and time at which the problem has been created;
   and the like.

### (Estimation Unit 13)

The estimation unit 13 performs performance estimation processing regarding any language model included in the language model group LLMG, with reference to the evaluation information EI acquired by the first acquisition unit 11 and the meta-information MIL of the at least one language model of the one or the plurality of language models included in the language model group LLMG. Here, in the estimation processing, the estimation unit 13 may further refer to the meta-information MIP of the one or the plurality of problems acquired by the third acquisition unit 14. As illustrated in FIG. 3, the estimation unit 13 includes, as an example, an inter-LLM similarity calculation unit 131, an inter-problem similarity calculation unit 132, a feature amount calculation unit 133, and an estimation score calculation unit 134. The processes in these units will be described later with reference to different drawings.

### (Output Information Generation Unit 15)

The output information generation unit 15 generates the output information OUT including the performance estimation result regarding the at least one of the one or the plurality of language models derived by the estimation unit 13. The output information may include at least one of the meta-information MIL of language model acquired by the second acquisition unit 12 and the meta-information MIP of problem acquired by the third acquisition unit 14. The output information OUT generated by the output information generation unit 15 will specifically be described later.

### (Processing Example by Information Processing Apparatus 1A)

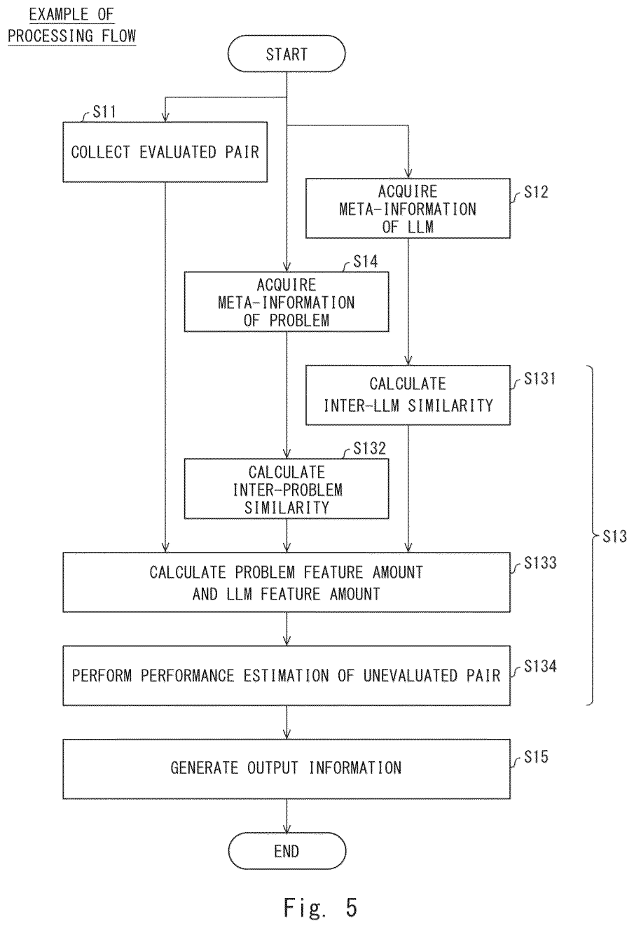

Next, processing examples by the information processing apparatus 1A will be described with reference to FIGS. 5 to 8. FIG. 5 is a flowchart illustrating a flow of processing by the information processing apparatus 1A.

### (Step S11)

In step S11, the first acquisition unit 11 collects one or a plurality of evaluated pairs as the evaluation information EI of the one or the plurality of language models included in the language model group LLMG. More specifically, the first acquisition unit 11 acquires the evaluation information EI including the score of the one or the plurality of evaluated pairs.

### (Step S12)

In step S12, the second acquisition unit 12 acquires the meta-information MIL of the at least one language model of the one or the plurality of language models included in the language model group LLMG.

### (Step S14)

In step S14, the third acquisition unit 14 acquires the meta-information MIP of the at least one problem of the one or the plurality of problems included in the problem group.

### (Step S131)

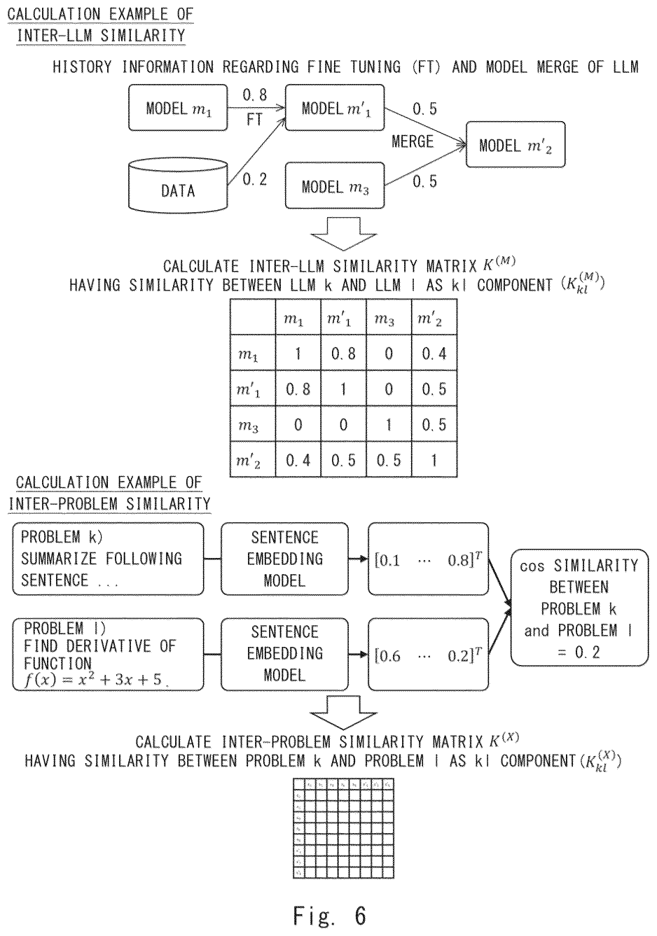

Subsequently, in step S131, the inter-LLM similarity calculation unit 131 calculates an inter-LLM similarity with reference to the meta-information MIL of language model acquired in step S12. An upper part of FIG. 6 illustrates a calculation example of the inter-LLM similarity by the inter-LLM similarity calculation unit 131. In the example illustrated in the upper part of FIG. 6, as the meta-information MIL of language model, processing with reference to the history information regarding fine tuning (FT) and model merge of the language model is illustrated.

The inter-LLM similarity calculation unit 131 sets weighting factors according to the model history, such as
a weighting factor for a fine-tuned model: 0.8
a weighting factor for a merged model: 0.5,
   and uses the weighting factors as the similarity between the models. In addition, for models having a history of a plurality of generations, a similarity between the models is calculated by multiplying weighting factors of the plurality of generations.

As an example, a relationship between the model m₁ and the model m₁′ is fine-tuning, and therefore the weighting factor 0.8 is set and this is used as a similarity between the model m₁ and the model m₁′. Further, a relationship between the model m₁′ and the model m₂′ is merge, and therefore the weighting factor 0.5 is set and this is used as a similarity between the model m₁′ and the model m₂′. Furthermore, 0.8×0.5=0.4 is calculated by the inter-LLM similarity calculation unit 131 as a similarity between the model m₁ and the model m₂′, and this is used as a similarity between the model m₁ and the model m₂′.

By performing such processing, the inter-LLM similarity calculation unit 131 calculates an inter-LLM similarity matrix K^{(M)} having a similarity between LLM (k) and LLM (l) as a kl component (K^{(M)}ₖₗ). Here, k and l are indexes for distinguishing a plurality of language models from each other.

Note that the setting example of the weighting factors does not limit the present exemplary example embodiment. As an example, different weighting factors may be used depending on the type of fine tuning, the type of merge, and the like.

Furthermore, the processing example of the inter-LLM similarity calculation unit 131 in this step is not limited to the above example. The inter-LLM similarity calculation unit 131 may be configured to calculate the inter-LLM similarity according to at least one of the following:
a similarity of parameters of language model or task parameters;
an internal state of a language model in a case where the language model solves a problem;
   and the like.

### (Step S132)

Subsequently, in step S132, the inter-problem similarity calculation unit 132 calculates an inter-problem similarity with reference to the meta-information MIP of problem acquired in step S14. A lower part of FIG. 6 illustrates a calculation example of the inter-problem similarity by the inter-problem similarity calculation unit 132. In the example illustrated in the lower part of FIG. 6, as the meta-information MIP of problem, processing with reference to a problem sentence of the problem is illustrated. More specifically, the inter-problem similarity calculation unit 132 performs the following processing:
inputting a problem sentence “summarize next sentence . . . ” of a problem (k) into a sentence embedding model; and
acquiring an embedding vector [0.1, . . . ,0.8]^{T} output by the sentence embedding model. In addition, the inter-problem similarity calculation unit 132 performs the following processing:
inputting a problem sentence “find derivative of function f(x)=x²+3x+5” of a problem (l) into a sentence embedding model; and
acquiring an embedding vector [0.6, . . . ,0.2]^{T} output by the sentence embedding model. Here, k and l are indexes for distinguishing a plurality of problems from each other. In addition, the inter-problem similarity calculation unit 132 performs the following processing:
calculating a cosine similarity between the embedding vectors [0.1, . . . ,0.8]^{T} and [0.6, . . . ,0.2]^{T}; and
using the calculated cosine similarity as a similarity between the problem (k) and the problem (l).

By performing such processing, the inter-problem similarity calculation unit 132 calculates an inter-problem similarity matrix K^{(X)} having the similarity between the problem (k) and the problem (l) as a kl component (K^{(X)}ₖₗ).

The processing example of the inter-problem similarity calculation unit 132 in this step is not limited to the above example. The inter-problem similarity calculation unit 132 may be configured to calculate the inter-problem similarity according to at least one of the following:
an inter-problem similarity using a sentence embedding model, the inter-problem similarity being based on an index other than the cosine similarity;
reranking using a generative model;
a similarity determined manually;
   and the like.

### (Step S133)

Subsequently, in step S133, the feature amount calculation unit 133
calculates the feature amount FP of each problem included in the problem group and the feature amount FL of each language model included in the language model group LLMG, with reference to:
the evaluated pair collected in step S11;
the inter-LLM similarity calculated in step S131; and
the inter-problem similarity calculated in step S132.

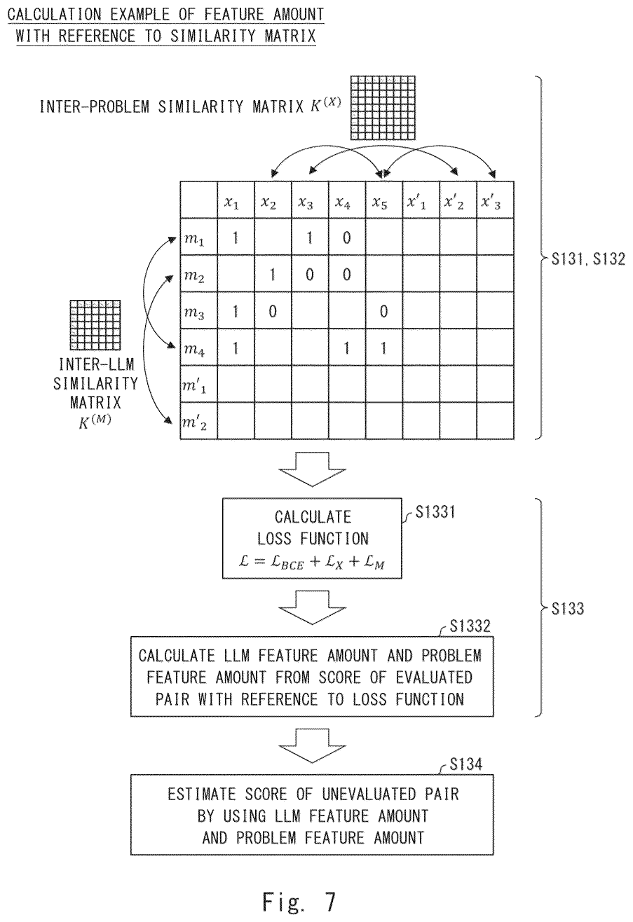

FIG. 7 illustrates a feature amount calculation processing example in this step. As illustrated in FIG. 7, step S133 includes, as an example, step S1331 of calculating a loss function and step S1332 of calculating a feature amount with reference to the loss function. In the following description, a case where a relationship between the feature amount FL of language model (LLM feature amount), the feature amount FP of problem, and the score is given by

$${z}_{ik} = f ( {m}_{i} , {x}_{k} ) = {m}_{i} \cdot {x}_{k} \qquad [ Mathematical formula 1 ]$$

is taken as an example. Here,

zᵢₖ∈ [symbol] :SCORE IN CASE WHERE LLM mᵢ SOLVES PROBLEM xₖ

mᵢ∈ [symbol] ^{d}:LLM FEATURE AMOUNT,M=[ . . . ,mᵢ, . . . ]∈ [symbol] ^{|M|×d}

xₖ∈ [symbol] ^{d}:PROBLEM FEATURE AMOUNT,X=[ . . . ,xₖ, . . . ]∈ [symbol] ^{|X|×d}. [Mathematical formula 2]

However, the above example does not limit the present processing example.

### (Step S1331)

In step S1331, the feature amount calculation unit 133 calculates a loss function L

$$ℒ = {ℒ}_{BCE} + {ℒ}_{X} + {ℒ}_{M} \qquad [ Mathematical formula 3 ]$$

Here, a first term on a right side of the formula 3 is a tolerance entropy term (loss function) L_{BCE} according to the evaluation information EI

$${ℒ}_{BCE} = - \frac{1}{N} {\sum }_{( i , k ) ∈ train} [ {z}_{ik} log ( σ ( {\hat{z}}_{ik} ) ) + ( 1 - {z}_{ik} ) log ( 1 - σ ( {\hat{z}}_{ik} ) ) ] \qquad [ Mathematical formula 4 ]$$

and in the formula 4,

\hat{z}iₖ:PREDICTED SCORE,zᵢₖ:TRUE SCORE. [Mathematical formula 5]

L_{BCE} may be referred to as a first loss. In addition, a second term on the right side of the formula 3 is a loss function (constraint term) L_{X}

$${ℒ}_{X} = {λ}_{X} \cdot tr ( {X}^{T} {L}^{( X )} X ) \qquad [ Mathematical formula 6 ]$$

$$where {L}^{( X )} = {D}^{( X )} - {A}_{kl}^{( X )} , {D}_{ij}^{( X )} = \{ \begin{matrix}{\sum }_{l} {A}_{il}^{( X )} ( i = j ) \\ 0 ( i \neq j )\end{matrix}$$

according to the inter-problem similarity calculated in step S132. Here, L^{(X)} is a graph Laplacian of an adjacency matrix A^{(X)}, and can be obtained as in a second line of the above formula 6 as an example. Furthermore, λ_{X} is a coefficient that defines the degree of contribution of the constraint term. Lₓ may be referred to as a third loss. In addition, a third term on the right side of the formula 3 is a loss function (constraint term) L_{M}

$${ℒ}_{M} = {λ}_{M} \cdot tr ( {X}^{T} {M}^{( M )} X ) \qquad [ Mathematical formula 7 ]$$

$$where {L}^{( M 〉} = {D}^{( M )} - {A}_{kl}^{( M )} , {D}_{ij}^{( M )} = \{ \begin{matrix}{\sum }_{l} {A}_{il}^{( M )} ( i = j ) \\ 0 ( i \neq j )\end{matrix}$$

according to the inter-model similarity calculated in step S131. Here, L^{(M)} is a graph Laplacian of an adjacency matrix A^{(M)}, and can be obtained as in a second line of the above formula 7 as an example. Furthermore, XM is a coefficient that defines the degree of contribution of the constraint term. L_{M} may be referred to as a second loss.

Here, the derivation of the constraint term Lₓ will specifically be described as follows. First, the feature amount calculation unit 133 converts the similarity matrix K^{(X)} into the adjacency matrix A^{(X)}. The adjacency matrix A^{(X)} may be referred to as a sparse matrix A^{(X)}. Here, the component K^{(X)}kl of the similarity matrix K^{(X)} is the similarity between the problem (k) and the problem (l) as described above. As described above, the cosine similarity or the like obtained in a case where the problem sentence (prompt) is converted into the sentence embedding vector can be used as the similarity.

On the other hand, a component of the adjacency matrix A^{(X)} is defined as

$${A}_{kl}^{( X )} = \{ \{ \begin{matrix}1 & CASE WHERE PROBLEM \text{?} IS IN TOP s PROBLEMS OF PROBLEM k , OR PROBLEM k IS INCLUDED IN TOP s NEIGHBORING PROBLEMS OF PROBLEM l \\ 0 & otherwise\end{matrix} . \qquad [ Mathematical formula 8 ]$$

$$\text{?} \text{indicates text missing or illegible when filed}$$

Then, the feature amount calculation unit 133 sets a loss term (loss function) that reduces a difference between feature amounts xₖ and x₁ between adjacent problems. As an example, the feature amount calculation unit 133 sets a loss term L_{X}

$${ℒ}_{X} = {λ}_{X} {\sum }_{kl} {A}_{kl}^{( X )} ‖ {x}_{k} - {x}_{l} ‖ \qquad [ Mathematical formula 9 ]$$

Here, xₖ is the feature amount of the problem k, and is also a learning target (update target). In other words, the feature amount calculation unit 133 performs processing of obtaining the problem feature amount xₖ that minimizes a loss.

If the formula 9 is transformed,

$$- {ℒ}_{X} = {λ}_{X} {\sum }_{kl} {A}_{k l}^{( X )} ‖ {x}_{k} - {x}_{l} ‖ = {λ}_{X} {\sum }_{kl} {A}_{k l}^{( X )} ( {x}_{k}^{T} {x}_{k} - 2 {x}_{k}^{T} {x}_{l} + {x}_{l}^{T} {x}_{l} ) = {λ}_{X} {\sum }_{kl} {A}_{k l}^{( X )} {x}_{k}^{T} {x}_{k} - 2 {\sum }_{kl} {A}_{k l}^{( X )} {x}_{k}^{T} {x}_{l} + {\sum }_{kl} {A}_{k l}^{( X )} {x}_{l}^{T} {x}_{l} ) \qquad [ Mathematical formula 10 ]$$

$$-= {λ}_{X} T r ( {X}^{T} ( D - A ) X ) = {λ}_{X} T r ( {X}^{T} LX )$$

and the formula 6 is obtained.

The derivation of the constraint term L_{M} will specifically be described as follows. First, the feature amount calculation unit 133 converts the similarity matrix K^{(M)} into the adjacency matrix A^{(M)}. The adjacency matrix A^{(M)} may be referred to as a sparse matrix A^{(M)}. Here, the component K^{(M)}ₖₗ of the similarity matrix K^{(M)} is the similarity between the language model (k) and the language model (l) as described above. As the similarity, as described above, as an example, it is possible to refer to the history information of the language model and use the weighting factor according to the history of the model as the similarity between the models.

On the other hand, a component of the adjacency matrix A^{(M)} is defined as

$$[ Mathematical formula 11 ]$$

$${A}_{k \text{?}}^{( M )} = \{ \begin{matrix}1 & CASE WHERE PROBLEM \text{?} IS IN TOP s PROBLEMS OF PROBLEM k , OR PROBLEM k IS INCLUDED IN TOP s NEIGHBORING PROBLEMS OF PROBLEM \text{?} \\ 0 & otherwise\end{matrix} .$$

$$\text{?} \text{indicates text missing or illegible when filed}$$

Then, the feature amount calculation unit 133 sets a loss term (loss function) that reduces a difference between feature amounts mₖ and mₗ between adjacent models. As an example, the feature amount calculation unit 133 sets a loss term L_{M}

$${ℒ}_{M} = {λ}_{M} {\sum }_{kl} {A}_{kl}^{( M )} ‖ {m}_{k} - {m}_{l} ‖ \qquad [ Mathematical formula 12 ]$$

Here, mₖ is the feature amount of the language model k, and is also a learning target (update target). In other words, the feature amount calculation unit 133 performs processing of obtaining the LLM feature amount mₖ that minimizes a loss.

If the formula 12 is transformed,

$$- {ℒ}_{M} = {λ}_{M} {\sum }_{kl} {A}_{k l}^{( M )} ‖ {m}_{k} - {m}_{l} ‖ = {λ}_{M} {\sum }_{kl} {A}_{k l}^{( M )} ( {m}_{k}^{T} {m}_{k} - 2 {m}_{k}^{T} {m}_{l} + {m}_{l}^{T} {m}_{l} ) = {λ}_{M} {\sum }_{kl} {A}_{k l}^{( M )} {m}_{k}^{T} {m}_{k} - 2 {\sum }_{kl} {A}_{k l}^{( M )} {m}_{k}^{T} {m}_{l} + {\sum }_{kl} {A}_{k l}^{( M )} {m}_{l}^{T} {m}_{l} ) \qquad [ Mathematical formula 13 ]$$

$$-= {λ}_{M} Tr ( {M}^{T} ( D - A ) M ) = {λ}_{M} Tr ( {M}^{T} LM )$$

and the formula 7 is obtained.

### (Step S1332)

Then, in step S1332, the feature amount calculation unit 133 calculates the feature amount of each problem and the feature amount of each language model in such a way that the loss function L is reduced, with reference to the score of the evaluated pair and the loss function L (formula 3) calculated in step S1331.

### (Step S134)

Then, in step S134, the estimation score calculation unit 134 calculates the score of the unevaluated pair by using the feature amount of each language model and the feature amount of each problem calculated in step S133. More specifically, by using the feature amount m₁ of the language model in the unevaluated pair and the feature amount xᵢ of the problem in the unevaluated pair, a score zᵢₖ of the unevaluated pair is calculated by

$${z}_{i k} = f ( {m}_{i} , {x}_{k} ) = {m}_{i} \cdot {x}_{k} . \qquad [ Mathematical formula 14 ]$$

### (Step S135)

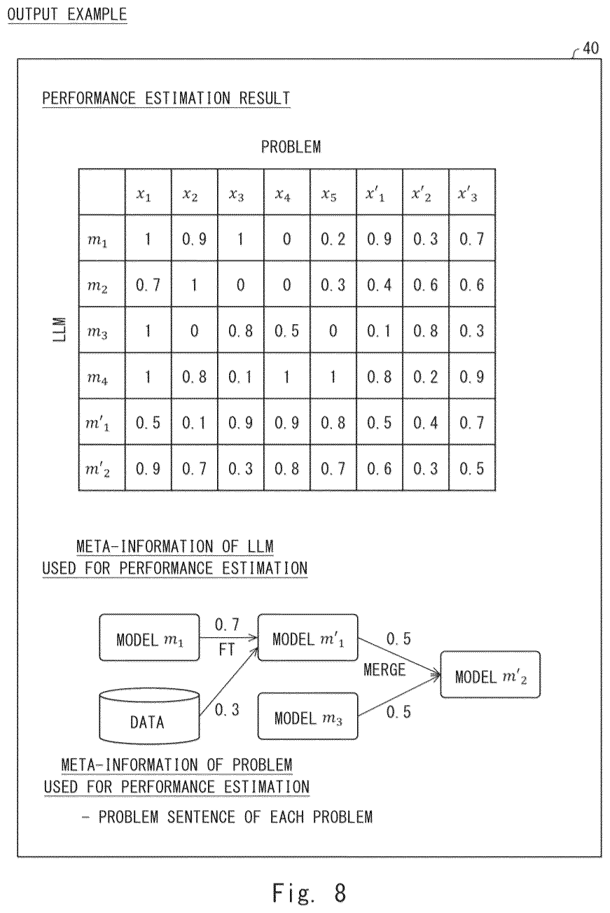

Then, in step S135, the output information generation unit 15 generates the output information OUT by using the performance estimation result including the score of the unevaluated pair calculated in step S134. FIG. 8 illustrates an example of the output information OUT visually presented via the display of the input/output unit 40. As illustrated in FIG. 8, the output information OUT includes the score of each unevaluated pair as the performance estimation result of each language model.

Further, as illustrated in FIG. 8, the output information OUT may include:
the meta-information MIL of the language model used for performance estimation;
the meta-information MIP of the problem used for performance estimation;
   and the like.

### (Effect of Information Processing Apparatus 1A)

As described above, the information processing apparatus 1A adopts the configuration that:
acquires the evaluation information EI of the at least one of the one or the plurality of language models, the evaluation information EI being the evaluation information EI of the language model related to the at least one of the one or the plurality of problems;
acquires the meta-information MIL regarding the at least one language model of the one or the plurality of language models; and
performs the performance estimation processing regarding the at least one of the one or the plurality of language models with reference to the evaluation information EI and the meta-information MIL. As described above, since the information processing apparatus 1A acquires the meta-information MIL regarding the at least one language model of the one or the plurality of language models and performs the performance estimation processing regarding the at least one of the one or the plurality of language models with reference to the meta-information MIL, performance estimation can suitably be performed even for the language model for which the evaluation information EI has not been obtained. As an example, according to the information processing apparatus 1A, as illustrated in FIG. 8, it is possible to suitably perform performance estimation even for the language models (m₁′ to m₂′) that have not solved any problem.

Further, the information processing apparatus 1A adopts a configuration that:
further acquires meta-information regarding the at least one problem of the one or the plurality of problems; and
performs the performance estimation processing with further reference to the meta-information regarding the problem. Therefore, the information processing apparatus 1A can suitably perform performance estimation even for a problem for which the evaluation information EI has not been obtained. As an example, according to the information processing apparatus 1A, as illustrated in FIG. 8, it is possible to suitably perform performance estimation even for the problems (x₁′ to x₃′) that have not been solved by any language model.

Further, in the performance estimation processing, since the information processing apparatus 1A adopts the configuration that:
with reference to the first loss L_{BCE} according to the score in the evaluated pair and the second loss L_{M} according to the meta-information MIL of the language model,
calculates,
for each of one or a plurality of language models, the feature amount FL of the language model, and
for each of one or a plurality of problems, the feature amount FP of the problem; and
with reference to the feature amount FL of the language model in the unevaluated pair and the feature amount FP of the problem in the unevaluated pair, estimates the score of the language model in the unevaluated pair, various effects described above can be obtained while suppressing an increase in calculation cost.

Hereinafter, an application example of the information processing system 100A will be described. In this example, a case is considered in which the language model group LLMG includes:
a language model A;
a language model B; and
a language model C,
and the server apparatus 60 receives an instruction to solve a problem group X including one or a plurality of problems from the information processing apparatus 1A or another apparatus via the communication unit 63. Here, these language models may include a language model for which evaluation information has not been obtained.

In this case, the server apparatus 60 transmits:
an instruction to perform evaluation as to which of the language models is suitable for the problem group X; and
some of the problems included in the problem group X
to the information processing apparatus 1A. Then, upon receiving the instruction, the information processing apparatus 1A acquires a score of an evaluated pair related to the language models A, B, and C and meta-information of the language models A, B, and C. Here, the score may be calculated by the information processing apparatus 1A or may be calculated by another apparatus.

Then, the information processing apparatus 1A performs performance estimation of each of the language models A, B, and C (calculation of an estimation score of an unevaluated pair) by performing the above-described performance evaluation processing by using a problem group X′ including some of the problems included in the problem group X. Then, the information processing apparatus 1A provides the performance estimation result to the server apparatus 60. The server apparatus 60 refers to the performance estimation result and selects a language model most suitable for the problem group X among the language models A, B, and C. Then, processing of actually solving the problem group X is performed by using the selected language model.

### [Example of Implementation by Software]

Some or all of the functions of the information processing apparatuses 1 and 1A (hereinafter, also referred to as “each of the above apparatuses”) may be implemented by hardware such as an integrated circuit (IC chip) or may be implemented by software.

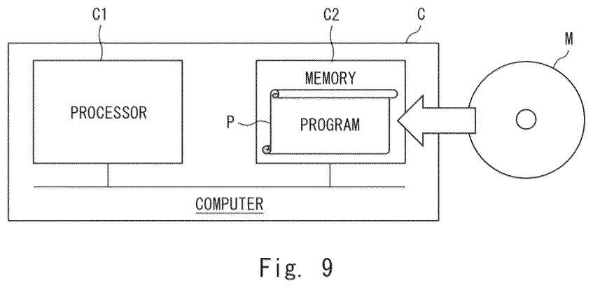

In the latter case, each of the above apparatuses is achieved by, for example, a computer that executes a command of a program as software for achieving each function. FIG. 9 illustrates an example of such a computer (hereinafter, referred to as a computer C). FIG. 9 is a block diagram illustrating a hardware configuration of the computer C functioning as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for sending and receiving data to and from another apparatus. The computer C may further include an input/output interface for connecting input/output equipment such as a keyboard, a mouse, a display, and a printer.

The program P can be recorded in a non-transitory tangible recording medium M readable by the computer C.

Examples of the recording media M include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), cards, programable logic circuits and semiconductor memories (such as mask ROM, PROM (programmable ROM), EPROM (erasable PROM), flash ROM, RAM (random access memory), etc.). The computer C can obtain the program P with the recording media M. In addition, the program P may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line. The computer C can obtain the program P with the transitory computer readable media.

Each of the above functions of each of the above apparatuses may be achieved by a single processor provided in a single computer, may be achieved in cooperation with a plurality of processors provided in a single computer, or may be achieved in cooperation with a plurality of processors provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Note Matter A]

The present disclosure includes the techniques described in the following Supplementary Notes. However, the present disclosure is not limited to the technologies described in the following Supplementary Notes, and various modifications can be made within the scope described in the claims.

### (Supplementary Note A1)

An information processing apparatus including:
a first acquisition means for acquiring evaluation information of at least one of one or a plurality of language models, the evaluation information being evaluation information of the language model related to at least one of one or a plurality of problems;
a second acquisition means for acquiring meta-information regarding the at least one language model of the one or the plurality of language models; and
an estimation means for performing performance estimation processing regarding the at least one of the one or the plurality of language models with reference to the evaluation information and the meta-information.

### (Supplementary Note A2)

The information processing apparatus according to Supplementary Note A1, wherein
the evaluation information includes
a score in an evaluated pair that is a pair of the at least one language model of the one or plurality of language models and a problem solved by the language model, and
the estimation means
estimates a score in an unevaluated pair that is a pair of a language model of one of the one or the plurality of language models and a problem that is not solved by the language model.

### (Supplementary Note A3)

The information processing apparatus according to Supplementary Note A2, wherein the estimation means estimates the score in the unevaluated pair with reference to a first loss according to the score in the evaluated pair and a second loss according to the meta-information.

### (Supplementary Note A4)

The information processing apparatus according to Supplementary Note A3, wherein the estimation means
calculates a similarity between the plurality of language models with reference to the meta-information, and
calculates the second loss by using the calculated similarity.

### (Supplementary Note A5)

The information processing apparatus according to Supplementary Note A3 or A4, wherein the estimation means
with reference to the first loss and the second loss,
calculates,
for each of the one or the plurality of language models, a feature amount of the language model, and,
for each of the one or the plurality of problems, a feature amount of the problem, and
estimates a score of the language model in the unevaluated pair, with reference to the feature amount of the language model in the unevaluated pair and the feature amount of the problem in the unevaluated pair.

### (Supplementary Note A6)

The information processing apparatus according to any one of Supplementary Notes A1 to A5, wherein the meta-information regarding the language model includes history information of the language model.

### (Supplementary Note A7)

The information processing apparatus according to Supplementary Note A6, including an output information generation means for generating output information including an estimation result by the estimation means and the history information.

### (Supplementary Note A8)

The information processing apparatus according to any one of Supplementary Notes A1 to A7, wherein
the acquisition means further includes a third acquisition means for acquiring meta-information regarding the at least one problem of the one or the plurality of problems, and
the estimation means performs the performance estimation processing with further reference to the meta-information regarding the problem.

### (Supplementary Note A9)

The information processing apparatus according to Supplementary Note A8, wherein the meta-information regarding the problem includes a problem sentence of the problem.

### [Supplementary Note Matter B]

The present disclosure includes the techniques described in the following Supplementary Notes. However, the present disclosure is not limited to the technologies described in the following Supplementary Notes, and various modifications can be made within the scope described in the claims.

### (Supplementary Note B1)

An information processing method including:
a first acquisition process in which at least one processor acquires evaluation information of at least one of one or a plurality of language models, the evaluation information being evaluation information of the language model related to at least one of one or a plurality of problems;
a second acquisition process in which the at least one processor acquires meta-information regarding the at least one language model of the one or the plurality of language models; and
an estimation process in which the at least one processor performs performance estimation processing regarding the at least one of the one or the plurality of language models with reference to the evaluation information and the meta-information.

### (Supplementary Note B2)

The information processing method according to Supplementary Note B1, wherein
the evaluation information includes
a score in an evaluated pair that is a pair of the at least one language model of the one or plurality of language models and a problem solved by the language model, and
in the estimation process, the at least one processor
estimates a score in an unevaluated pair that is a pair of a language model of one of the one or the plurality of language models and a problem that is not solved by the language model.

### (Supplementary Note B3)

The information processing method according to Supplementary Note B2, wherein, in the estimation process, the at least one processor estimates the score in the unevaluated pair with reference to a first loss according to the score in the evaluated pair and a second loss according to the meta-information.

### (Supplementary Note B4)

The information processing method according to Supplementary Note B3, wherein, in the estimation process, the at least one processor
calculates a similarity between the plurality of language models with reference to the meta-information, and
calculates the second loss by using the calculated similarity.

### (Supplementary Note B5)

The information processing method according to Supplementary Note B3 or B4, wherein, in the estimation process, the at least one processor
with reference to the first loss and the second loss,
calculates,
for each of the one or the plurality of language models, a feature amount of the language model, and,
for each of the one or the plurality of problems, a feature amount of the problem, and
estimates a score of the language model in the unevaluated pair, with reference to the feature amount of the language model in the unevaluated pair and the feature amount of the problem in the unevaluated pair.

### (Supplementary Note B6)

The information processing method according to any one of Supplementary Notes B1 to B5, wherein the meta-information regarding the language model includes history information of the language model.

### (Supplementary Note B7)

The information processing method according to Supplementary Note B6, including an output information generation process in which the at least one processor generates output information including an estimation result by the estimation process and the history information.

### (Supplementary Note B8)

The information processing method according to any one of Supplementary Notes B1 to B7, wherein
the acquisition process further includes a third acquisition process in which the at least one processor acquires meta-information regarding the at least one problem of the one or the plurality of problems, and
in the estimation process, the at least one processor performs the performance estimation processing with further reference to the meta-information regarding the problem.

### (Supplementary Note B9)

The information processing method according to Supplementary Note B8, wherein the meta-information regarding the problem includes a problem sentence of the problem.

### [Supplementary Note Matter C]

The present disclosure includes the techniques described in the following Supplementary Notes. However, the present disclosure is not limited to the technologies described in the following Supplementary Notes, and various modifications can be made within the scope described in the claims.

### (Supplementary Note C1)

An information processing program for causing a computer to function as an information processing apparatus, the program causing the computer to function as:
a first acquisition means for acquiring evaluation information of at least one of one or a plurality of language models, the evaluation information being evaluation information of the language model related to at least one of one or a plurality of problems;
a second acquisition means for acquiring meta-information regarding the at least one language model of the one or the plurality of language models; and
an estimation means for performing performance estimation processing regarding the at least one of the one or the plurality of language models with reference to the evaluation information and the meta-information.

### (Supplementary Note C2)

The information processing program according to Supplementary Note C1, wherein
the evaluation information includes
a score in an evaluated pair that is a pair of the at least one language model of the one or plurality of language models and a problem solved by the language model, and
the estimation means
estimates a score in an unevaluated pair that is a pair of a language model of one of the one or the plurality of language models and a problem that is not solved by the language model.

### (Supplementary Note C3)

The information processing program according to Supplementary Note C2, wherein the estimation means estimates the score in the unevaluated pair with reference to a first loss according to the score in the evaluated pair and a second loss according to the meta-information.

### (Supplementary Note C4)

The information processing program according to Supplementary Note C3, wherein the estimation means
calculates a similarity between the plurality of language models with reference to the meta-information, and
calculates the second loss by using the calculated similarity.

### (Supplementary Note C5)

The information processing program according to Supplementary Note C3 or C4, wherein the estimation means
with reference to the first loss and the second loss,
calculates,
for each of the one or the plurality of language models, a feature amount of the language model, and,
for each of the one or the plurality of problems, a feature amount of the problem, and
estimates a score of the language model in the unevaluated pair, with reference to the feature amount of the language model in the unevaluated pair and the feature amount of the problem in the unevaluated pair.

### (Supplementary Note C6)

The information processing program according to any one of Supplementary Notes C1 to C5, wherein the meta-information regarding the language model includes history information of the language model.

### (Supplementary Note C7)

The information processing program according to Supplementary Note C6, wherein the computer is caused to execute an output information generation process of generating output information including an estimation result by the estimation means and the history information.

### (Supplementary Note C8)

The information processing program according to any one of Supplementary Notes C1 to C7, wherein the computer is caused to execute in such a way that
the acquisition means is caused to further function as a third acquisition means for acquiring meta-information regarding the at least one problem of the one or the plurality of problems, and
the estimation means performs the performance estimation processing with further reference to the meta-information regarding the problem.

### (Supplementary Note C9)

The information processing program according to Supplementary Note C8, wherein the meta-information regarding the problem includes a problem sentence of the problem.

### [Supplementary Note Matter D]

The present disclosure includes the techniques described in the following Supplementary Notes. However, the present disclosure is not limited to the technologies described in the following Supplementary Notes, and various modifications can be made within the scope described in the claims.

### (Supplementary Note D1)

An information processing apparatus including at least one processor, wherein the at least one processor performs:
a first acquisition process of acquiring evaluation information of at least one of one or a plurality of language models, the evaluation information being evaluation information of the language model related to at least one of one or a plurality of problems;
a second acquisition process of acquiring meta-information regarding the at least one language model of the one or the plurality of language models; and
an estimation process of performing performance estimation processing regarding the at least one of the one or the plurality of language models with reference to the evaluation information and the meta-information.

The information processing apparatus may further include a memory. The memory may store a program for causing the at least one processor to perform each of the processes.

### (Supplementary Note D2)

The information processing apparatus according to Supplementary Note D1, wherein
the evaluation information includes
a score in an evaluated pair that is a pair of the at least one language model of the one or plurality of language models and a problem solved by the language model, and
in the estimation process, the at least one processor
estimates a score in an unevaluated pair that is a pair of a language model of one of the one or the plurality of language models and a problem that is not solved by the language model.

### (Supplementary Note D3)

The information processing apparatus according to Supplementary Note D2, wherein, in the estimation process, the at least one processor estimates the score in the unevaluated pair with reference to a first loss according to the score in the evaluated pair and a second loss according to the meta-information.

### (Supplementary Note D4)

The information processing apparatus according to Supplementary Note D3, wherein, in the estimation process, the at least one processor
calculates a similarity between the plurality of language models with reference to the meta-information, and
calculates the second loss by using the calculated similarity.

### (Supplementary Note D5)

The information processing apparatus according to Supplementary Note D3 or D4, wherein, in the estimation process, the at least one processor
with reference to the first loss and the second loss,
calculates,
for each of the one or the plurality of language models, a feature amount of the language model, and,
for each of the one or the plurality of problems, a feature amount of the problem, and
estimates a score of the language model in the unevaluated pair, with reference to the feature amount of the language model in the unevaluated pair and the feature amount of the problem in the unevaluated pair.

### (Supplementary Note D6)

The information processing apparatus according to any one of Supplementary Notes D1 to D5, wherein the meta-information regarding the language model includes history information of the language model.

### (Supplementary Note D7)

The information processing apparatus according to Supplementary Note D6, wherein the at least one processor performs an output information generation process of generating output information including an estimation result by the estimation process and the history information.

### (Supplementary Note D8)

The information processing apparatus according to any one of Supplementary Notes D1 to D7, wherein the at least one processor is caused to execute in such a way that
the acquisition process further includes a third acquisition process in which the at least one processor acquires meta-information regarding the at least one problem of the one or the plurality of problems, and
in the estimation process, the at least one processor performs the performance estimation processing with further reference to the meta-information regarding the problem.

### (Supplementary Note D9)

The information processing apparatus according to Supplementary Note D8, wherein the meta-information regarding the problem includes a problem sentence of the problem.

### [Supplementary Note Matter E]

The present disclosure includes the techniques described in the following Supplementary Notes. However, the present disclosure is not limited to the technologies described in the following Supplementary Notes, and various modifications can be made within the scope described in the claims.

### (Supplementary Note E1)

A non-transitory recording medium recording an information processing program for causing a computer to function as an information processing apparatus, the program causing the computer to perform:
a first acquisition process of acquiring evaluation information of at least one of one or a plurality of language models, the evaluation information being evaluation information of the language model related to at least one of one or a plurality of problems;
a second acquisition process of acquiring meta-information regarding the at least one language model of the one or the plurality of language models; and
an estimation process of performing performance estimation processing regarding the at least one of the one or the plurality of language models with reference to the evaluation information and the meta-information.

What is claimed is:

1. An information processing apparatus comprising:
one or more memories that store an instruction; and
one or more processors that execute the instruction, wherein the one or more processors execute the instruction to perform:
acquiring evaluation information of at least one of one or a plurality of language models, the evaluation information being evaluation information of the language model related to at least one of one or a plurality of problems;
acquiring meta-information regarding the at least one language model of the one or the plurality of language models; and
performing performance estimation processing regarding the at least one of the one or the plurality of language models with reference to the evaluation information and the meta-information.

2. The information processing apparatus according to claim 1, wherein
the evaluation information includes a score in an evaluated pair that is a pair of the at least one language model of the one or plurality of language models and a problem solved by the language model, and
the one or more processors execute the instruction to perform estimating a score in an unevaluated pair that is a pair of a language model of one of the one or the plurality of language models and a problem that is not solved by the language model.

3. The information processing apparatus according to claim 2, wherein the one or more processors execute the instruction to perform estimating the score in the unevaluated pair with reference to a first loss according to the score in the evaluated pair and a second loss according to the meta-information.

4. The information processing apparatus according to claim 3, wherein the one or more processors execute the instruction to perform:
calculating a similarity between the plurality of language models with reference to the meta-information; and
calculating the second loss by using the calculated similarity.

5. The information processing apparatus according to claim 3, wherein the one or more processors execute the instruction to perform:
calculating, with reference to the first loss and the second loss,
for each of the one or the plurality of language models, a feature amount of the language model, and,
for each of the one or the plurality of problems, a feature amount of the problem; and
estimating a score of the language model in the unevaluated pair, with reference to the feature amount of the language model in the unevaluated pair and the feature amount of the problem in the unevaluated pair.

6. The information processing apparatus according to claim 1, wherein the meta-information regarding the language model includes history information of the language model.

7. The information processing apparatus according to claim 6, wherein the one or more processors execute the instruction to perform generating output information including an estimation result of the performance estimation processing and the history information.

8. The information processing apparatus according to claim 1, wherein the one or more processors execute the instruction to perform:
acquiring meta-information regarding the at least one problem of the one or the plurality of problems; and
performing the performance estimation processing with further reference to the meta-information regarding the problem.

9. An information processing method comprising causing one or more processors to perform:
acquiring evaluation information of at least one of one or a plurality of language models, the evaluation information being evaluation information of the language model related to at least one of one or a plurality of problems;
acquiring meta-information regarding the at least one language model of the one or the plurality of language models; and
performing performance estimation processing regarding the at least one of the one or the plurality of language models with reference to the evaluation information and the meta-information.

10. A non-transitory computer readable medium storing a program for causing a computer to perform:
acquiring evaluation information of at least one of one or a plurality of language models, the evaluation information being evaluation information of the language model related to at least one of one or a plurality of problems;
acquiring meta-information regarding the at least one language model of the one or the plurality of language models; and
performing performance estimation processing regarding the at least one of the one or the plurality of language models with reference to the evaluation information and the meta-information.
